(19) United States
(12) Patent Application Publication
(10) Pub. No.: US 2017/0043898 A1
(43) Pub. Date: Feb. 16, 2017

(54) MANDREL FOR SLEEVE LABELER

(71) Applicant: ABBOTT LABORATORIES, ABBOTT PARK, IL (US)

(72) Inventors: Waverly Worsham, JR., Lynch Station, VA (US); Hank Arthur, Evington, VA (US)

(73) Assignee: ABBOTT LABORATORIES, ABBOTT PARK, IL (US)

(21) Appl. No.: 15/307,211

(22) PCT Filed: Apr. 27, 2015
(86) PCT No.: PCT/US15/27769

§ 371 Date: Oct. 27, 2016

Related U.S. Application Data
(60) Provisional application No. 61/985,841, filed on Apr. 29, 2014.

(51) Int. Cl. B65C 3/06; B29C 63/42

(52) U.S. Cl. CPC B65C 3/065; B29C 63/423

(57) ABSTRACT

A mandrel extension (10) for use in a sleeve film labeler. The mandrel extension may include a body (12), a first guide rail (30) and a second guide rail (32). The body has a front face (16), a rear face (18), a first end (14) and two elongated sides (20, 22). The first guide rail is attached to one of the two elongated sides and the second guide rail is attached to the other of the two elongated sides. At least one of the first guide rail and the second guide rail may extend outward from the body to define a width of the mandrel extension relative to a travel direction of the sleeve film.

### CROSS-REFERENCE TO RELATED APPLICATIONS

This application claims priority to and the benefit of U.S. Provisional Patent Application No. 61/985,841, filed Apr. 29, 2014, the entire content of which is incorporated by reference herein.

### BACKGROUND

Many consumer products are packaged in a plastic bottle. A plastic bottle may be further packaged to include a plastic sleeve label.

In a packaging process for a bottle and plastic sleeve, a continuous roll of plastic may be fed into a bottling machine, or more specifically, into a sleeve film labeler. A mandrel extension may be a first point of contact for a continuous sleeve film in a bottling machine. The roll is fed over a mandrel assembly to open the roll. Different size extensions may be used depending on the width of the plastic roll.

The continuous roll is typically cut into individual sleeves just before the sleeve is placed onto the bottle, typically from a position above the bottle. The sleeve is shrunk wrapped over the bottle to be held in place throughout the remainder of the packaging process.

### SUMMARY

The present application describes a mandrel extension for use in a sleeve film labeler.

In an exemplary embodiment, a mandrel extension includes a body. The body may have a front face, a rear face, a first end and two elongated sides. The mandrel extension may include a first guide rail attached to one of the two elongated sides and a second guide rail attached to the other of the two elongated sides. The first guide rail and the second guide rail may extend outward from the body to define a width of the mandrel extension relative to a travel direction of the sleeve film.

Further features and advantages of the invention will become apparent from the following detailed description made with reference to the accompanying drawings.

### BRIEF DESCRIPTION OF THE DRAWINGS

Features and advantages of the general inventive concepts will become apparent from the following detailed description made with reference to the accompanying drawings.

FIG. 1 is a front perspective view of a mandrel extension;

FIG. 2 is an enlarged front perspective view of a portion of the mandrel extension of FIG. 1;

FIG. 3 is an enlarged front view of a portion of the mandrel extension of FIG. 1;

FIG. 4 is a top view of the mandrel extension of FIG. 1;

FIG. 5 is a rear view of a portion of the mandrel extension of FIG. 1, showing a beginning of a roll of sleeve film in an adjacent position near a top of the mandrel extension; and

FIG. 6 is side view of a portion of the mandrel extension of FIG. 1, showing a roll of sleeve film in an open and descended position on a portion of the mandrel extension.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, percentages and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The present application describes a mandrel extension for use with a sleeve film labeler. The mandrel extension has several advantageous features. For example, one embodiment of the mandrel extension includes guide rails on either side of a main body. The guide rails act as a film guide and may be adjustable in position to permit variances in label film dimension. With this feature, label film is kept flatter compared to film on conventional mandrels. Further, the coefficient of friction of the film is reduced to prohibit undesired wrinkles or folding of the film. A thicker mandrel extension body is another advantageous feature. The thicker body prohibits a gap between the mandrel and the film to prevent label film from being snagged or torn. The body shape also makes it easier to load and thread new film material over the mandrel. Other advantages are discussed herein.

One embodiment of the invention features a mandrel extension including a body, a first guide rail, and a second guide rail. The body has a front face, a rear face, a first end and two elongated sides. The first guide rail is attached to one of the two elongated sides. A second guide rail is attached to the other of the two elongated sides. At least one of the first guide rail and the second guide rail extend outward from the body to define a width of the mandrel extension relative to a travel direction of the sleeve film.

Another embodiment of the invention features a mandrel extension including a body having a front face, a rear face, a first end and two elongated sides. The first end defines a convex-shaped edge. At least a portion of the front face is planar and angled toward the rear face in a direction toward the first end, or, that is to say, angled away from the rear face in a direction away from the first end.

Another embodiment of the invention features a method for loading a mandrel extension onto a sleeve film labeler. The method includes selecting a sleeve film having a predetermined width, and providing a mandrel extension. The mandrel extension includes a body, a first guide rail, and a second guide rail. The body has a front face, a rear face, a first end, a second end and two elongated sides. The first guide rail is attachable to one of the two elongated sides. The second guide rail is attachable to the other of the two elongated sides. At least one of the first guide rail and the second guide rail extend outward from the body to define a width of the mandrel extension relative to a travel direction of the sleeve film. The method includes securing the first guide rail and the second guide rail to a predetermined position. The predetermined position of the first guide rail and the second guide rail define a predetermined width of the mandrel extension. The method includes securing the mandrel extension to the sleeve film labeler, with the first end upstream relative to the second end with respect to the travel direction of the sleeve film.

Exemplary embodiments of the invention will now be discussed. When discussing the invention, a mandrel extension will be discussed for use in a sleeve labeler. The exemplary discussion and figures are directed to a mandrel extension mounted above a travel path of bottles and below a roll of film. The film travels in a downward direction over the mandrel extension and onto the bottle. The present invention may be practiced with film traveling in any other direction, with the mandrel extension mounted in the proper orientation for the film direction.

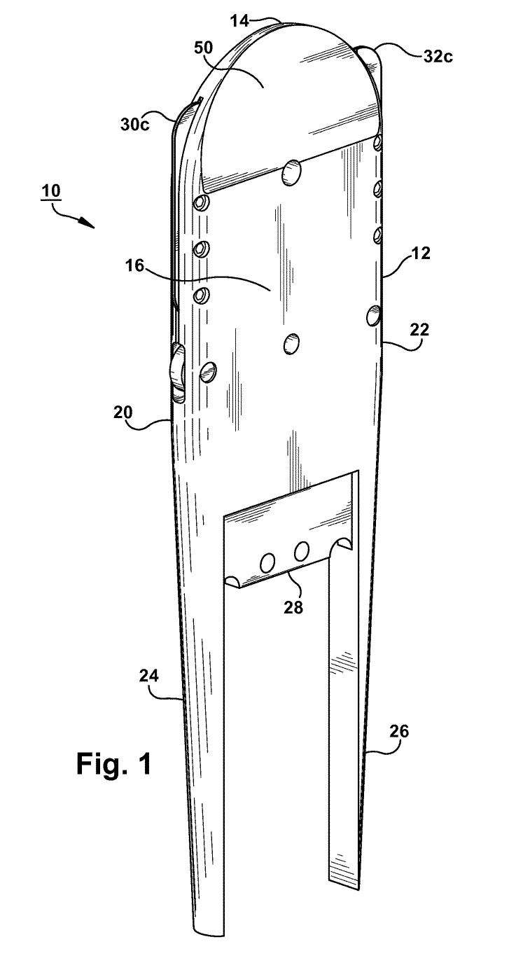

Referring now to the drawings, a front perspective view of a mandrel extension is shown in FIG. 1. The mandrel extension 10 is shaped for use in a sleeve film labeler, or in any semi-automated or automated machine which installs a single piece of film around all or part of the circumference of a container, such as for example, a plastic bottle. As a roll of film unwinds, the sleeve of continuous film is rolled onto the mandrel extension 10 and initially contacts a first end 14. The sleeve film travels the length of the mandrel extension in a slightly opened, two-panel position. For discussion purposes, portions of the mandrel extension will be referred to in relation to a positioning of the mandrel extension, such as for example, a top portion, a middle portion, and a bottom portion, or with reference to each other in the direction of sleeve film travel, such as for example, upstream or downstream. During travel over the mandrel extension, the width and the thickness of the opening of the sleeve film is determined by the mandrel extension.

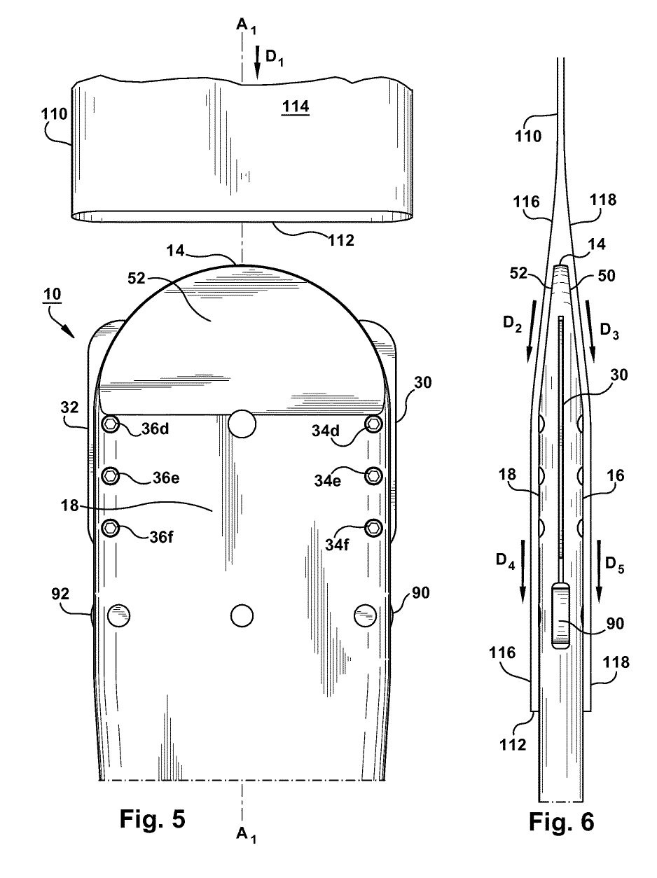

Still referring to FIG. 1, the mandrel extension includes a body 12 having a front face 16 and a rear face 18 (see FIG. 5). The front face 16 and rear face 16 are generally smooth and, in parts, are generally parallel to each other. In use, the sleeve film passes over the front face 16 and the rear face 18 after the sleeve film has been opened to a predetermined width (see FIG. 6). The width and thickness of the mandrel extension 10 vary in certain portions to promote opening and movement of the sleeve film. The mandrel extension is formed from a durable and hard material which will withstand a high volume production environment.

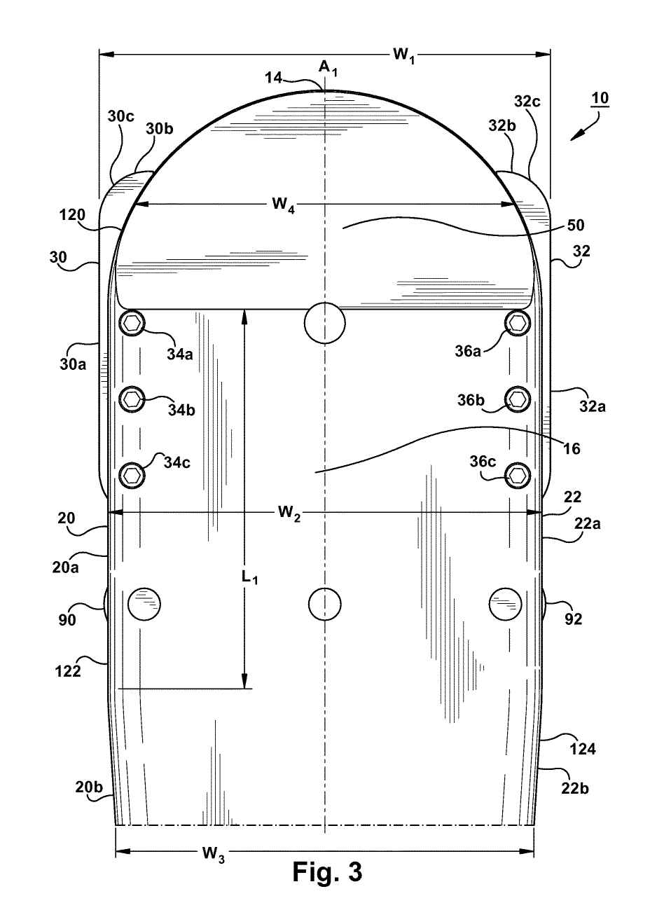

The top portion of the body 12 is shaped to facilitate opening of the sleeve film. The body 12 includes a convex-shaped first end 14, a front face 16 and a rear face 18, and two elongated edges, or sides 20, 22. The curved first end 14 of the body 12 is advantageously shaped to benefit loading and opening of the sleeve film. The two elongated sides 20, 22 may form one or more portions of the length of the body. For example and as best seen in FIG. 3, a first elongated side 20 includes an upper portion 20a which is linear and parallel to an upper portion 22a of a second elongated side 22. The first elongated side 20 also includes a lower portion 20b which is angled inward toward a lower portion 22b of a second elongated side 22. As shown in FIG. 3, the length of an outer edge of the first guide rail is substantially parallel to an opposing length of an outer edge of the second guide rail. In other embodiments, the two elongated sides may have different relationships in regard to each other, and may have more or less than two distinguishable portions.

The shape and size of the bottom portion of the mandrel extension may vary and may be adapted for the application environment. For example, the exemplary mandrel extension 10 illustrated in FIG. 1 includes two prongs 24, 26. The prongs 24, 26 partially frame a tongue 28. The tongue 28 is of a reduced width and thickness as compared to the main portion of the body 10. In this arrangement, the mandrel extension can be mounted on and secured to a downstream section of the film labeler. In the practice of the invention, the structure of the mandrel extension used for mounting onto the film labeler may vary in location, shape or size.

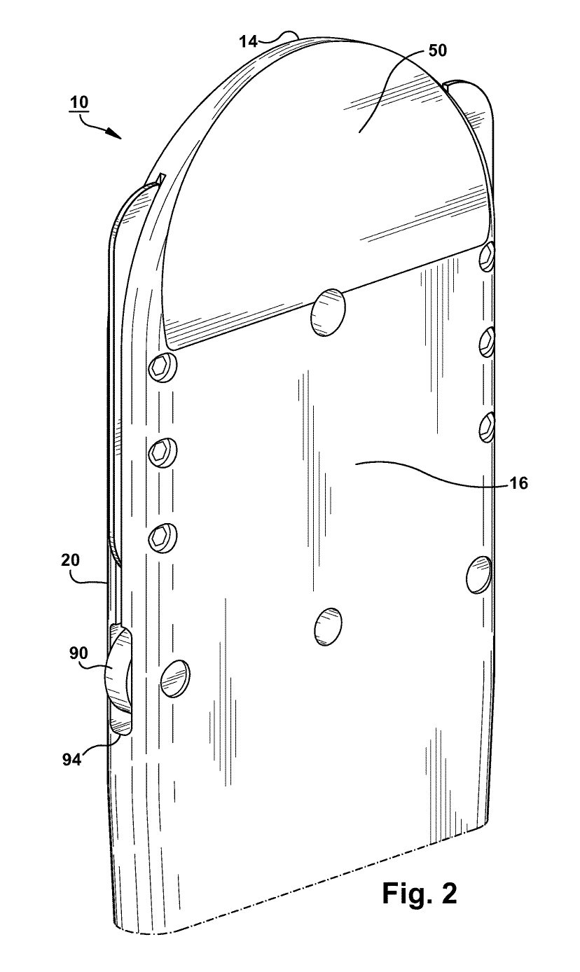

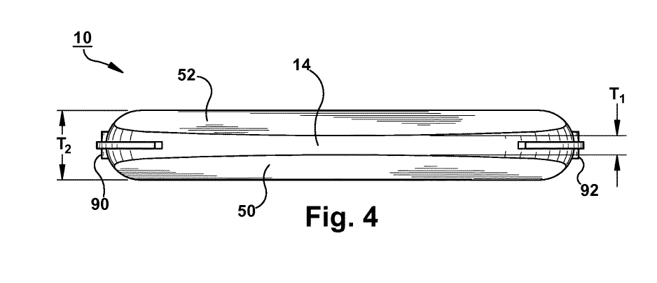

Referring now to FIGS. 2-4, additional structural detail of the exemplary mandrel extension 10 is shown. FIGS. 2 and 3 are enlarged front perspective and enlarged front views of an upper portion of the mandrel extension 10. A top view of the mandrel extension 10 is shown in FIG. 4. The mandrel extension includes structure for adjusting the width to accommodate various sizes of sleeve film, each having a different width. Two guide rails extend out from an elongated side of the body to define a width of the mandrel extension relative to a travel direction of the sleeve film. A first guide rail 30 is attached to the first elongated side 20. The first guide rail 30 includes an outer edge 30a in a parallel relationship with at least a portion of the first elongated side 20, and with a longitudinal axis A₁ of the mandrel extension 10. An upper edge 30b of the first guide rail 30 faces toward the oncoming sleeve film, and is separated from the outer edge 30a by an arcuate, or rounded corner 30c. The first guide rail 30 is shown for exemplary purposes, and the shape, size and position of the first guide rail may vary in the practice of the invention.

A second guide rail 32 is shaped and positioned similarly to the first guide rail 30. A second guide rail 32 is attached to the second elongated side 22. The second guide rail 32 includes an outer edge 32a in a parallel relationship with at least a portion of the second elongated side 32, and with a longitudinal axis A₁ on the mandrel extension 10. An upper edge 32b of the second guide rail 32 faces toward the oncoming sleeve film, and is separated from the outer edge 32a by an arcuate, or rounded corner 32c. The second guide rail 32 is shown for exemplary purposes, and the shape, size and position of the second guide rail may vary in the practice of the invention. The number of the guide rails may also vary in the practice of the invention.

As discussed herein, the width of the mandrel extension relative to a travel direction of the sleeve film may be adjusted. The width is adjusted by adjusting the position of at least one of the guide rails relative to the body of the mandrel. At least one of the first guide rail and second guide rail are removably fixed to the body at one of a plurality of locations. As such, an operator of the film labeler may make adjustments to the width of the mandrel extension to accommodate a sleeve film of various widths without having to inventory a collection of mandrel extensions, with each mandrel extension sin the collection being sized for an individual width of sleeve film.

In the exemplary mandrel extension 10 show in the FIG. 3, the overall width W₁ of the mandrel extension 10 may be adjusted by adjusting the position of one or both of the guide rails 30, 32. The position of the first guide rail 30 may be adjusted by loosening a set of screws 34a, 34b, 34c, which are attached to threaded holes in the body 12, and adjusting, for example, sliding, the position of the first guide rail 30 relative to the body 12. Similarly screws 36a, 36b, 36c are attached to the threaded holes on the opposing side of the first face 16 of the body 12. The position of the second guide rail 32 may be adjusted by loosening this set of screws 36a, 36b, 36c and adjusting, for example, sliding, the position of the second guide rail 32 relative to the body 12. As can be seen in FIG. 5, similar hardware 34d, 34e, 34f, 36d, 36e, 36f are included on the rear face 18 of the body 12. It should be apparent to one skilled in the art that the position of a guard rail may be adjusted, and a guide rail may be removably fixed to the body, by other hardware, structure, or methods.

As discussed herein, the mandrel extension is shaped and sized to promote the opening of the sleeve film and the downstream movement of the sleeve film. In fact, all three dimensions of the mandrel extension are advantageously shaped. For example, the mandrel extension is shaped to gently open the sleeve roll from an initial loading width to a predetermined width. The front face 16 includes a front angled surface 50 which is planar and angled toward the rear face 18 in a direction toward the first end 14, or angled away from the rear face 18 in a downstream direction. Similarly, the rear face 18 includes a rear angled surface 52 which is planar and angled toward the rear face 18 in a direction toward the first end 14, or angled away from the front face 16 in a downstream direction. As shown in the top view of the mandrel extension 10 in FIG. 4, the front angled surface 50 and the rear angled surface 52 each angle away from each other in the downstream direction. The present invention may be practiced with the slope of one or more faces being less or more than is illustrated, and the length of the angled face being more or less, for example, the slope of the front angled surface 50 may be as little as 10 degrees relative the first face 16, or as much as 30 degrees, 45 degrees, or 60 degrees. In the practice of the invention, the slope of front angled surface 50 and the rear angled surface 52 may be the same as each other or may be different.

The thickness of the body also varies throughout the body of the mandrel extension. For example, the thickness of the body 12 increases along the length of the body in the direction away from the front end 14, that is to say, a downstream direction. That feature is illustrated in the relationship of the front angled surface 50 and the rear angled surface 52 in FIG. 6. Also, the thickness of the body 12 increases in either direction away from the longitudinal axis A₁ of the mandrel extension 10. For example, this feature is illustrated in the shape of the front end 14 in FIG. 4. Also, the width of the body 12 increases in either direction away from the longitudinal axis A₁ of the mandrel extension 10, as the sleeve film moves in the downstream direction over the front angled surface 50 and the rear angled surface area 52. For example, this feature is illustrated in the shape of the rear angled surface 52 in FIG. 5. As such, the sleeve film opens gently, and with reduced friction, as it passes over the mandrel extension 10, first opening in the middle of the sleeve film and then also slowly outward in either direction.

The mandrel extension 10 also includes structure to reduce friction of the sleeve film on the mandrel extension 10 after the opening and initial movement. For example, a roller may be removably fixed to at least one of the two elongated sides. The roller extends outward from the body and may be positioned downstream relative to the guide rail with respect to the travel direction of the sleeve film. Exemplary rollers 90, 92 are illustrated in the Figures on the elongated sides 20, 22, respectively. The rollers are mounted such that only a portion of the roller is in position to contact the sleeve film. For example, a roller 90 is partially mounted within a cavity 94 on the first elongated side 20, as shown in FIG. 2. The size, number, and position of rollers may vary in the practice of the invention.

The mandrel extension can be further discussed by viewing the body as having up to two distinguishable portions, that is to say, an upstream first portion and a downstream second portion. The exemplary mandrel extension 10 in the Figures includes a third portion as well. The sleeve film travels in a direction from the first portion to the second portion. The width of the body in the first portion, the second portion, and the third portion varies to promote sleeve film movement. For example, FIG. 3 shows an exemplary body portion 12 having a first portion 120, a second portion 122, and a third portion 124. A width of the second portion is constant along a length of the second portion. In the exemplary second portion 122 of FIG. 3, the width is the same along the entire length L₁ of the second portion 122. For example, FIG. 3 illustrates a second portion 122 having a width W₂ which is constant along an entire length L₁ of the second portion. The width W₃ of the third portion 124 decreases along a length of the third portion in a direction away from the second portion. Similarly, a width of the first portion 120 decreases along a length of the first portion 120 in a direction away from the second portion 122.

The thickness of the first portion and the second portion also varies to promote film sleeve movement. A thickness of the first portion 120 increases along a length of the first portion in a direction toward the second portion 122. In other words, the first portion 120 is thinnest along the first end 14 at the longitudinal axis A₁ of the mandrel extension 10, or, the initial upstream thickness T₁ of the first portion 120 is the thinnest. This gradually thickening of the first portion 120 in the downstream direction causes the gradually opening of the sleeve film.

The second portion is sized and shaped for minimal friction as the sleeve film travels toward an area of the sleeve film labeler for further processing. For example, the thickness of the second portion is equal along a length of the second portion. This feature is illustrated in the exemplary body 12 shown in FIGS. 3 and 4. For example, the thickness T₂ of the second portion 122 is equal along an entire length L₁ of the second portion 122.

A method for loading a mandrel extension onto a sleeve film labeler, and corresponding movement of the sleeve film over the mandrel extension, will now be discussed. FIG. 5 is a rear view of a portion of the mandrel extension 10. A roll of sleeve film (not shown) is in a position near and above the mandrel extension 10. The sleeve film has a predetermined width selected for the particular container onto which it will be applied. An end portion 114 of the sleeve film 110 defines an opening 112, as shown in FIG. 5, and has a first panel 116 and a second panel 118. The structure of the film panel may vary in the practice of the invention. For example, the sleeve film may have a pattern of holes throughout the film.

A mandrel extension is provided having an adjustable width. A range of widths of the mandrel extension is suitable for the particular width of the sleeve film. In discussing the method of use on the mandrel extension, the exemplary mandrel extension 10 from FIGS. 1-4 is used. As discussed herein, certain features of the mandrel extension may vary from the exemplary mandrel extension 10 in the practice of the invention.

Before the sleeve film is loaded onto the mandrel extension, the first guide rail and the second guide rail are secured to a predetermined position. As discussed, the predetermined position of the first guide rail 30 and the second guide rail 32 define a predetermined width of the mandrel extension. Further, the user may secure the first guide rail and the second guide rail to a predetermined position wherein a length of an outer edge of the first guide rail is substantially parallel to an opposing length of an outer edge of the second guide rail. For example, the first guide rail 30 and the second guide rail 32 are shown in a substantially parallel position in FIG. 5.

The mandrel extension must be secured to the sleeve film labeler. In this secured position, the first end 14 of the body 12 is upstream relative to the second end with respect to the travel direction of the sleeve film. The mandrel extension may be secured to the sleeve film labeler before, during or after adjusting the width of the mandrel extension.

FIG. 6 is side view of a portion of the mandrel extension of FIG. 1, showing a roll of sleeve film in an open and descended position on the mandrel extension. In this position, the two panels 116, 118 are traveling in a direction D₂, D₃, down the sides of the angled surfaces 50, 52, respectively. The lead portion of the sleeve film 110 has traveled past the rollers 90, 92 and is in a parallel position with each other, moving in a direction D₄, D₅, respectively.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A mandrel extension for use in a sleeve film labeler, the mandrel extension comprising:
a body having a front face, a rear face, a first end and two elongated sides; and
a first guide rail attached to one of the two elongated sides and a second guide rail attached to the other of the two elongated sides;
wherein at least one of the first guide rail and the second guide rail extend outward from the body to define a width of the mandrel extension relative to a travel direction of the sleeve film.

2. The mandrel extension of claim 1, wherein the first end defines an arcuate edge.

3. The mandrel extension of claim 1, wherein the first end defines a convex-shaped edge.

4. The mandrel extension of claim 1, wherein at least one of the first guide rail and the second guide rail are removably fixed to the body at one of a plurality of locations, wherein a width of the mandrel extension is adjustable.

5. The mandrel extension of claim 1, wherein at least a portion of at least one of the front face and the rear face is planar and angled toward the rear face in a direction toward the first end.

6. (canceled)

7. The mandrel extension of claim 1, wherein a length of an outer edge of the first guide rail is substantially parallel to an opposing length of an outer edge of the second guide rail.

8. The mandrel extension of claim 1, wherein at least one of the first guide rail and the second guide rail have a side, a first end, and an arcuate corner between the side and the first end.

9. The mandrel extension of claim 1, wherein the body has a first portion, a second portion, and a third portion, and wherein the film travels in a direction from the first portion to the third portion.

10. The mandrel extension of claim 9, wherein a width of the second portion is constant along a length of the second portion.

11. (canceled)

12. The mandrel extension of claim 9, wherein a width of the third portion decreases along a length of the third portion in a direction away from the second portion.

13. The mandrel extension of claim 9, wherein a width of the first portion decreases along a length of the first portion in a direction away from the second portion.

14. The mandrel extension of claim 9, wherein a thickness of the second portion is equal along a length of the second portion.

15. (canceled)

16. The mandrel extension of claim 9, wherein a thickness of the first portion decreases along a length of the first portion in a direction away from the second portion.

17. A mandrel extension for use in a sleeve film labeler, the mandrel extension comprising:
a body having a front face, a rear face, a first end and two elongated sides;
wherein the first end defines a convex-shaped edge and at least a portion of the front face is planar and angled toward the rear face in a direction toward the first end.

18. The mandrel extension of claim 17, wherein at least one of a width of the body and a thickness of the body increases along a length of the body in a direction away from the first end.

19. (canceled)

20. The mandrel extension of claim 17, further comprising:
a guide rail removably fixed to at least one of the two elongated sides;
wherein the guide rail extends outward from the body to define a width of the mandrel extension relative to a travel direction of the sleeve film.

21. The mandrel extension of claim 20, wherein the guide rail has a side, a first end, and an arcuate corner between the side and the first end wherein the guide rail is removably fixed to the body at one of a plurality of locations, and wherein a width of the mandrel extension is adjustable.

22. (canceled)

23. The mandrel extension of claim 20, further comprising:
a roller removably fixed to the at least one of the two elongated sides;
wherein the roller extends outward from the body and is downstream relative to the guide rail removably fixed to the at least one of the two elongated sides with respect to the travel direction of the sleeve film.

24. A method for loading a mandrel extension onto a sleeve film labeler, the method comprising:
selecting a sleeve film having a predetermined width;
providing a mandrel extension comprising:
a body having a front face, a rear face, a first end, a second end and two elongated sides; and
a first guide rail attachable to one of the two elongated sides and a second guide rail attachable to the other of the two elongated sides;
wherein at least one of the first guide rail and the second guide rail extend outward from the body to define a width of the mandrel extension relative to a travel direction of the sleeve film;
securing the first guide rail and the second guide rail to a predetermined position, wherein the predetermined position of the first guide rail and the second guide rail define a predetermined width of the mandrel extension;
securing the mandrel extension to the sleeve film labeler, wherein the first end is upstream relative to the second end with respect to the travel direction of the sleeve film.

25. The method of claim 24, further comprising:
securing the first guide rail and the second guide rail to a predetermined position wherein a length of an outer edge of the first guide rail is substantially parallel to an opposing length of an outer edge of the second guide rail.
